(19) United States
(12) Patent Application Publication
(10) Pub. No.: US 2013/0041679 A1
(43) Pub. Date: Feb. 14, 2013

(54) ORDER DISPLAY APPARATUS, COMPUTER READABLE STORAGE MEDIUM, AND ORDER DISPLAY METHOD

(71) Applicants: Kenichi Kanagawa, Ota (JP); Yukio Saito, Ota (JP)

(72) Inventors: Kenichi Kanagawa, Ota (JP); Yukio Saito, Ota (JP)

(73) Assignee: FUJITSU LIMITED, Kawasaki-shi (JP)

(21) Appl. No.: 13/571,924

(22) Filed: Aug. 10, 2012

(30) Foreign Application Priority Data
Aug. 12, 2011 (JP) 2011-177299

(51) Int. Cl. G06Q 50/22

(52) U.S. Cl. 705/2

(57) ABSTRACT

An order display apparatus disclosed in this application includes an extracting unit and a generating unit in one aspect. The extracting unit extracts orders having a designated period within the implementation periods thereof, from a storage unit that stores change information indicating the relationships between one order among orders issued by doctors and the other orders among the issued orders, and the implementation period during which the one order is executed. If the orders extracted by the extracting unit include a second order having the change information indicating that the second order has been changed from a first order, the generating unit performs the following operation. The generating unit has the first order and the second order displayed adjacent to each other on a display screen that displays at least some of the extracted orders in accordance with the passage of time during the designated period.

### CROSS-REFERENCE TO RELATED APPLICATION

This application is based upon and claims the benefit of priority of the prior Japanese Patent Application No. 2011-177299, filed on Aug. 12, 2011, the entire contents of which are incorporated herein by reference.

### FIELD

The embodiments discussed herein are directed to an order display apparatus, a computer readable storage medium, and an order display method.

### BACKGROUND

In recent years, electronic medical record systems have been widely used at medical institutions. Users who use an electronic medical record system registers medical information such as subjects' diagnoses and test results in a database of the electronic medical record system. The users include healthcare professionals such as doctors, nurses, and pharmacists. The subjects include not only patients such as sick and injured persons, but also healthy people such as those undergoing a medical checkup and expectant and nursing mothers. In the following, medical records to be used in the electronic medical record system will be referred to as “electronic medical records”.

In the electronic medical record system, doctors issue instructions as orders to medical professionals. The orders issued by doctors include orders such as “Measure blood pressure once a day” and “Allow administration of medicine A for vomiting up to 2 times”.

As a large number of orders are issued to inpatients, the electronic medical record system has a function to display a list of orders, for example. This function allows the users to see a list of the orders to be executed on the day among orders issued to respective subjects, for example.

Patent Document 1: Japanese Laid-open Patent Publication No. 2006-155072

Patent Document 2: Japanese Laid-open Patent Publication No. 2010-134544

Non-Patent Document 1: Toshiba Medical Information Systems Corporation, “Electronic Medical Records/Order System, HAPPY ACCEL-ER” on the Internet (URL: http://www.tsmed.co.jp/tsmed/happy/accel-er.htm)

In medical practice, there are cases where an already issued order is changed, depending on changes in the symptoms of the subject or the conditions of medical facilities. In a case where there is improvement in the symptoms of the subject, for example, an already issued order “Measure blood pressure 3 times a day” is changed to an order “Measure blood pressure once a day” at some point. In the database, not only the changed order but also the pre-changed order is recorded.

In the above described conventional art, when a list of orders is displayed, the orders are displayed in the chronological order of issuance. Therefore, even in a case where the list contains a pre-changed order and a changed order, some other order might be inserted and displayed between the pre-changed and changed orders, and the process of the order change difficult to be clearly displayed.

### SUMMARY

According to an aspect of an embodiment, an order display apparatus includes an extracting unit and a generating unit. The extracting unit extracts orders having a designated period within the implementation periods thereof, from a storage unit that stores change information indicating the relationships between one order among orders issued by doctors and the other orders among the issued orders, and the implementation period during which the one order is executed. The generating unit has a first order and a second order displayed adjacent to each other on a display screen that displays at least some of the extracted orders in accordance with the passage of time during the designated period, when the orders extracted by the extracting unit include the second order having the change information that indicates that the second order has been changed from the first order.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the functional structure of an order display apparatus according to a first embodiment;

FIG. 2 is a table illustrating an example data structure in the order storage unit;

FIG. 3A is a table illustrating an example data structure in the list storage unit;

FIG. 3B is a table illustrating another example data structure in the list storage unit;

FIG. 3C is a table illustrating yet another example data structure in the list storage unit;

FIG. 4 is a table for explaining an operation of the extracting unit;

FIG. 5 is a diagram illustrating an example of a display screen generated by the generating unit;

FIG. 6 is a diagram for explaining an operation of the changing unit;

FIG. 7 is a diagram for explaining an operation of the changing unit;

FIG. 8 is a table for explaining an operation of the changing unit;

FIG. 9 is a diagram for explaining an operation of the changing unit;

FIG. 10 is a flowchart illustrating the procedures in an operation of the order display apparatus according to the first embodiment;

FIG. 11 is a flowchart illustrating the procedures in an order changing operation;

FIG. 12 is a diagram for explaining an example of an application to a data center; and

FIG. 13 is a diagram illustrating an example of a computer that executes an order display program.

### DESCRIPTION OF EMBODIMENTS

Preferred embodiments of the present invention will be explained with reference to accompanying drawings.

Further, the invention is not limited by the embodiments. The embodiments can be appropriately combined to each other unless there is no inconsistency in processing contents.

### First Embodiment

### Structure

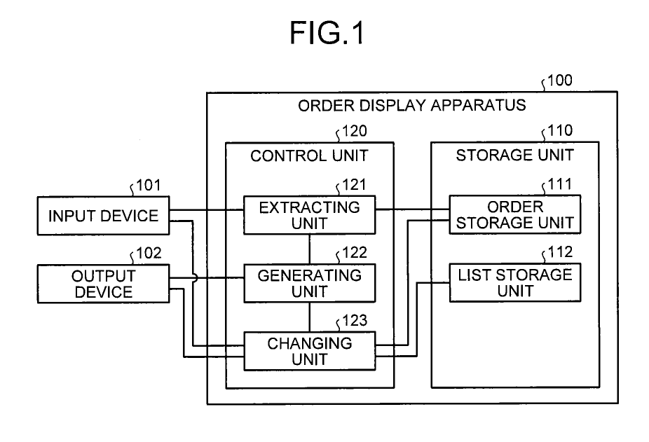

An example function structure of an order display apparatus according to a first embodiment is described. FIG. 1 is a block diagram illustrating the function structure of the order display apparatus according to the first embodiment. As illustrated in FIG. 1, this order display apparatus 100 includes a storage unit 110 and a control unit 120. Also, the order display apparatus 100 is connected to an input device 101 and an output device 102. The order display apparatus 100 is equivalent to a personal computer, for example.

The input device 101 receives inputs of various kinds of information. For example, the input device 101 receives an input to designate a period from a user. The input device 101 also receives an input to designate an order from a user, for example. The input device 101 may also output various kinds of received information to an extracting unit 121 and a changing unit 123. The input device 101 is equivalent to a keyboard and a mouse, a medium reading device, or a sensor such as a thermometer or a hygrometer. Users include healthcare professionals such as doctors, nurses, and pharmacists. Subjects include not only patients such as sick and injured persons, but also healthy people such as those undergoing a medical checkup and expectant and nursing mothers. In the following, medical records to be used in the order display apparatus 100 will be referred to as “electronic medical records”.

The output device 102 outputs various kinds of information. The output device 102 may display a display screen generated by a generating unit 122, for example. The output device 102 may also display a change screen for changing orders, for example. The output device 102 is equivalent to a display or a monitor, for example.

The storage unit 110 includes an order storage unit 111 and a list storage unit 112. The storage unit 110 is equivalent to a semiconductor memory device such as a RAM (Random Access Memory), a ROM (Read Only Memory), or a flash memory, or a storage device such as a hard disk or an optical disk.

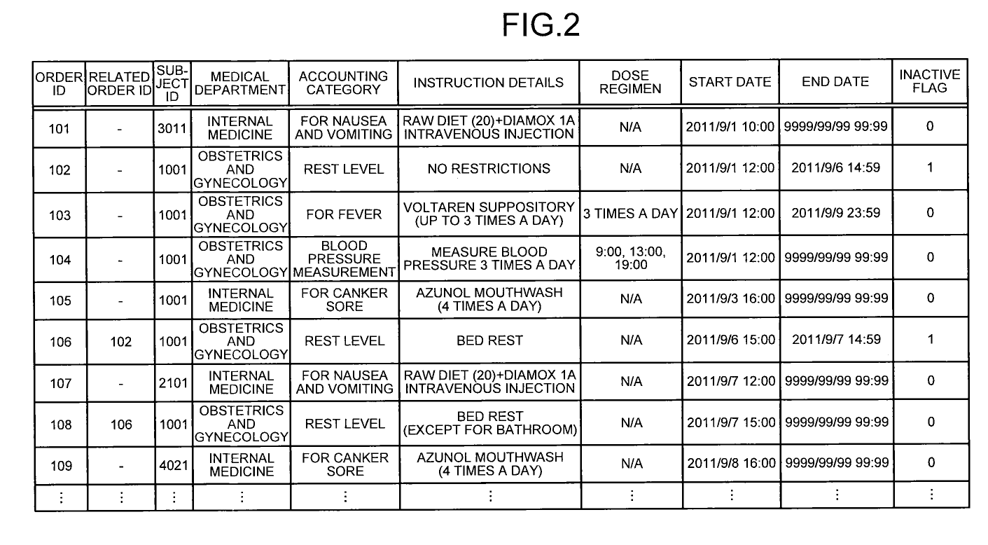

The order storage unit 111 stores change information indicating the relationships between one order among orders issued by doctors and the other orders, and the implementation period during which the one order is executed, for example. The order storage unit 111 stores orders issued by doctors, for example. FIG. 2 is a table illustrating an example of a data structure in the order storage unit. As illustrated in FIG. 2, the order storage unit 111 stores “Order ID”, “Related Order ID”, “Subject ID”, “Medical Department”, “Accounting Category”, “Instruction Details”, “Dose Regimen”, “Start Date”, “End Date”, and “Inactive flag”, which are associated with one another. Among those, each order ID (Identification) is the identification number for uniquely identifying an order issued by a doctor. Each related order ID represents the order ID of the pre-changed order corresponding to a changed order. In a case where the order corresponding to an order ID is a changed order, the order ID corresponding to the pre-changed is stored as the related order ID. For example, a related order ID “106” indicates that the corresponding order is a changed order, and the pre-changed order is the order with an order ID “102”. Also, each related order ID “-” indicates that the corresponding order has no related order IDs. In other words, each related order ID “-” indicates that the corresponding order is not a changed order. Each subject ID is the identification number uniquely identifying a subject. Each medical department indicates the medical department that has issued the corresponding order. For example, a medical department “Obstetrics and Gynecology” indicates that the order has been issued by the obstetrics and gynecology department. Each accounting category indicates the group into which the corresponding order is classified in accordance with the details of the order. For example, an accounting category “For Nausea and Vomiting” indicates that the corresponding order belongs to a “For Nausea and Vomiting” group. Instruction details indicate the instruction details of the corresponding order. For example, instruction details “Voltaren suppository (up to 3 times a day)” indicate that a Voltaren suppository should be given to the subject up to 3 times a day. Each dose regimen indicates the dose regimen of the corresponding order. For example, a dose regimen “3 times a day” indicates that the corresponding order should be executed three times a day. Each start date indicates the date on which the corresponding order becomes valid. For example, a start date “2011/9/1 10:00” indicates that the corresponding order becomes valid at 10:00 on Sep. 1, 2011. In a case where the instruction is executed upon issuance of the order, the date of issuance of the order is registered as the start date. In a case where an order is issued in the form of a reservation, and the instruction is executed after the issuance, the date on which the order is executed for the first time is registered as the start date. Each end date indicates the date on which the corresponding order becomes invalid. For example, an end date “2011/9/6 14:59” indicates that the corresponding order is valid until 14:59 on Sep. 6, 2011. An end date “9999/99/99 99:99” indicates that the end date of the corresponding order has not been set, for example. An unset end date of the corresponding order will be hereinafter referred to as a “date unset”. Each inactive flag indicates that the corresponding order has been changed. For example, an inactive flag “1” indicates that the corresponding order has been changed, and an inactive flag “0” indicates that the corresponding order has not been changed. In each inactive flag, “0” is registered by default, for example. One record is registered in the order storage unit 111 every time a doctor issues an order. It should be noted that each related order ID is an example of change information.

As illustrated in FIG. 2, the order storage unit 111 stores the order ID “106”, the related order ID “102”, a subject ID “1001”, the medical department “Obstetrics and Gynecology”, an accounting category “Rest level”, instruction details “Bed Rest”, and a dose regimen “N/A”, which are associated with one another. Further, the order storage unit 111 stores a start date “2011/9/6 15:00”, an end date “2011/9/7 14:59”, and the inactive flag “1”, which are associated with one another. That is, the order storage unit 111 stores information indicating that the order with the order ID “106” is an order changed from the order with the order ID “102”, and is an instruction as to the subject with the subject ID “1001”. Further, the order storage unit 111 stores information indicating that the order with the order ID “106” is an order under the accounting category of “Rest level” issued from the obstetrics and gynecology department, the instruction details are “Bed Rest”, and no special dose regimens have been designated. Further, the order storage unit 111 stores information indicating that the order with the order ID “106” is valid from 15:00 on Sep. 6, 2011, until 14:59 on Sep. 7, 2011, and has been changed to another order. The order storage unit 111 also stores details of other orders. In the following, each order having a related order ID attached thereto will also be referred to as a “changed order”, and each order identified by a related order ID will also be referred to as a “pre-changed order”.

The list storage unit 112 stores order lists issued by doctors. The list storage unit 112 stores a medical department list containing medical departments, for example. The list storage unit 112 also stores accounting category lists containing accounting categories of the respective medical departments, for example. The list storage unit 112 also stores order lists containing orders under the respective accounting categories, for example.

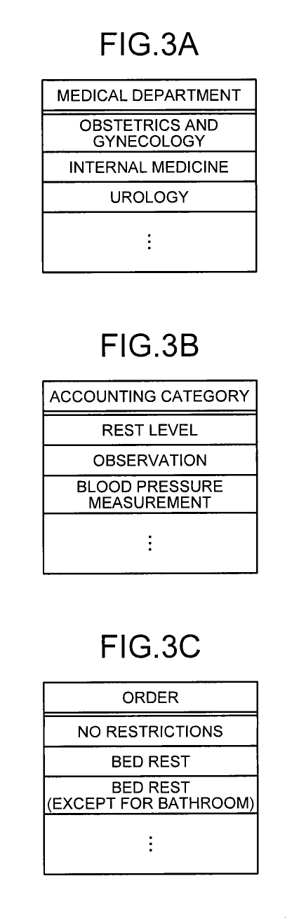

FIGS. 3A through 3C are tables each illustrating an example data structure in the list storage unit. As illustrated in FIG. 3A, the medical category list stored in the list storage unit 112 contains medical departments such as “Obstetrics and Gynecology”, “Internal Medicine”, and “Urology”, for example. The list storage unit 112 also stores an accounting category list for “Obstetrics and Gynecology”, for example. As illustrated in FIG. 3B, the accounting category list of the obstetrics and gynecology department stored in the list storage unit 112 contains accounting categories such as “Rest level”, “Observation”, and “Blood Pressure Measurement”, for example. The list storage unit 112 also stores an order list about “Rest Level”, for example. As illustrated in FIG. 3C, the rest level order list stored in the list storage unit 112 contains instruction details such as “No Restrictions”, “Bed Rest”, and “Bed Rest (Except for Bathroom)”. The medical department list, the accounting category lists, and the order lists, which are stored in the list storage unit 112, are set for each medical institution, for example. Also, the medical department list, the accounting category lists, and the order lists, which are stored in the list storage unit 112, are arbitrarily added, deleted, or modified by those who use the order display apparatus 100.

The control unit 120 includes the extracting unit 121, the generating unit 122, and the changing unit 123. The functions of the control unit 120 can be realized by an integrated circuit such as an ASIC (Application Specific Integrated Circuit) or a FPGA (Field Programmable Gate Array), for example. Alternatively, the functions of the control unit 120 can be realized by a CPU (Central Processing Unit) executing a predetermined program, for example.

The extracting unit 121 extracts orders having a designated period within the implementation periods thereof from the order storage unit 111. For example, the extracting unit 121 extracts orders that are valid during the designated period, from the order storage unit 111. The extracting unit 121 receives an input to designate a period from a user, for example. The extracting unit 121 then extracts the orders that are valid during the designated period, from the order storage unit 111. The extracting unit 121 outputs the extracted orders to the generating unit 122.

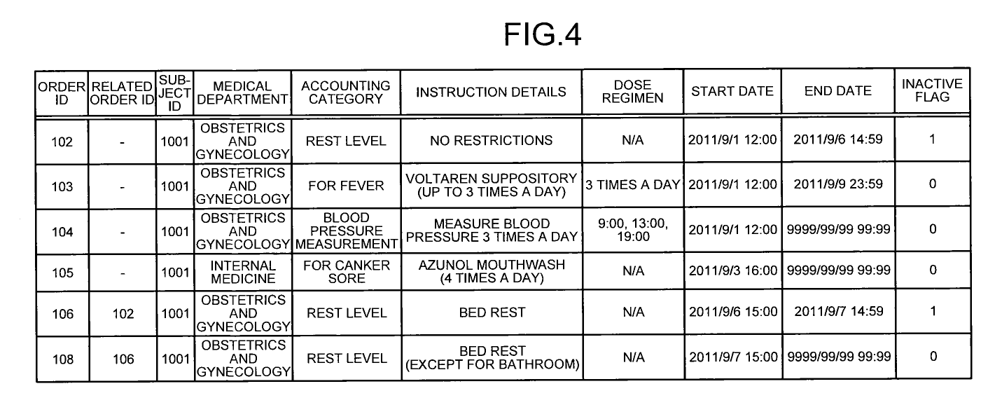

When the extracting unit 121 receives an input of a date designated for a subject from a user, for example, the extracting unit 121 extracts the orders that are valid during a predetermined period including the designated date, from the order storage unit 111. In the following, a case where a date “Sep. 7, 2011” is designated for the subject with the subject ID “1001”, and the extracting unit 121 extracts orders from the order storage unit 111 is described. The predetermined period is the period from two days before the designated date until 7 days after the designated date. In this case, the extracting unit 121 extracts, from the order storage unit 111, orders with the subject ID “1001”, a start date before “2011/9/14 23:59”, and an end date after “2011/9/5 00:00”. Here, a date unset is determined to be later than any end date. For example, when orders are extracted from the order storage unit 111 illustrated in FIG. 2 under the above conditions, the extracting unit 121 extracts the orders satisfying the above conditions, as illustrated in FIG. 4. FIG. 4 is a table for explaining an operation of the extracting unit. As illustrated in FIG. 4, the extracting unit 121 extracts “Order ID”, “Related Order ID”, “Subject ID”, “Medical Department”, “Accounting Category”, “Instruction Details”, “Dose Regimen”, “Start Date”, “End Date”, and “Inactive flag” of each of the orders satisfying the above described conditions. The predetermined period is not limited to the above mentioned period, but may be arbitrarily set by a user of the order display apparatus 100. Further, the extracting unit 121 may extract corresponding orders in accordance with the medical department, the section, or the hospital ward to which the user belongs.

In a case where the orders extracted by the extracting unit 121 include a second order having change information indicating a change from a first order, the generating unit 122 performs the following operation. The generating unit 122 has the first order and the second order displayed adjacent to each other on a display screen that displays at least some of the extracted orders in accordance with the passage of time during the designated period. For example, in a case where there is a changed second order to which change information indicating a change from a first order is attached when the generating unit 122 is about to generate a display screen based on the extracted orders, the generating unit 122 generates the display screen that displays the first order and the second order adjacent to each other. This display screen is a display screen that displays the passage of time during the period associated with the orders that are valid during the time.

The generating unit 122 also has a first implementation period and a second implementation period displayed on the display screen, so that the connection between the end date of the first implementation period of the first order and the start date of the second implementation period of the second order can be recognized, for example.

The generating unit 122 arranges the orders extracted by the extracting unit 121 according to medical department, for example. The generating unit 122 further arranges the orders, which have been arranged according to medical department, according to accounting category. If there is a changed order among the orders arranged according to accounting category, the generating unit 122 puts the changed order under the corresponding pre-changed order. The generating unit 122 generates a display screen in the sequence of the arranged orders, and causes the output device 102 to output the generated display screen.

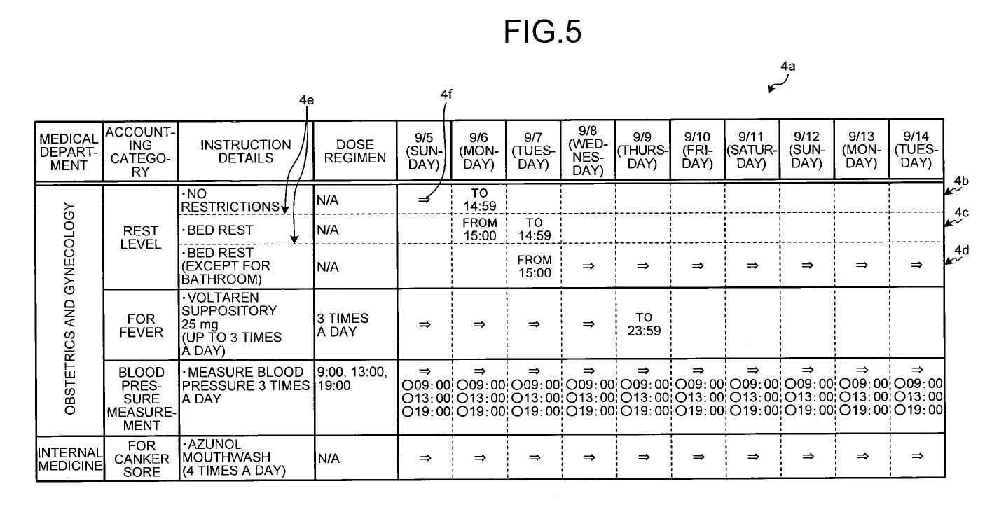

Referring now to FIG. 5, a display screen generated by the generating unit is described. FIG. 5 is a diagram illustrating an example of a display screen generated by the generating unit. FIG. 5 illustrates a display screen 4a generated by the generating unit 122 based on the orders listed in FIG. 4. As illustrated in FIG. 5, the display screen 4a displays the medical department, accounting category, instruction details, dose regimen, and period of each order. The period is displayed on a daily basis from Sep. 5, 2011, until Sep. 14, 2011, in the example of FIG. 5. In the medical department column on the display screen 4a, the orders are classified into “Obstetrics and Gynecology” and “Internal Medicine”. In the accounting category column of the obstetrics and gynecology department on the display screen 4a, the orders are classified into “Rest Level”, “For Fever”, and “Blood Pressure Measurement”. In the instruction details column of the rest levels on the display screen 4a, the orders are classified into “No Restrictions”, “Bed Rest”, and “Bed Rest (Except for Bathroom”. In the period columns on the display screen 4a, arrows 4f are displayed where respective orders are valid all day. Where orders are valid from a predetermined time, “15:00˜” is displayed, for example. Where orders are valid until a predetermined time, “˜14:00” is displayed, for example. Although the period is displayed on the display screen 4a on a daily basis in this embodiment, the present invention is not limited to that. For example, the period may be displayed on an hourly basis. This is because the passage of time should be displayed on the display screen 4a.

Since the related order ID “102” is attached to the order ID “106” listed in FIG. 4, for example, the generating unit 122 puts the order with the order ID “106” under the order with the order ID “102”. Also, since the related order ID “106” is attached to an order ID “108” listed in FIG. 4, for example, the generating unit 122 puts the order with the order ID “108” under the order with the order ID “106”. That is, on the display screen 4a, an order 4b corresponds to the order with the order ID “102”, and an order 4c corresponds to the order with the order ID “106”, and an order 4d corresponds to the order with the order ID “108”. Also, the generating unit 122 displays lines 4e with dashed lines indicating the boundaries on which each pre-changed order is adjacent to the corresponding changed order. Although the lines 4e are displayed with dashed lines in this embodiment, the present invention is not limited to that. For example, the lines 4e may be displayed with two-dot dashed lines. This is because each line 4e indicating a boundary on which a pre-changed order is adjacent to the corresponding changed order should be distinguished from lines indicating boundaries on which orders not involved in changes are adjacent to one another.

Upon receipt of an instruction to change a first order stored in the order storage unit 111 to a second order, the changing unit 123 attaches change information indicating the change from the first order to the second order, and stores the change information and the changed order into the order storage unit 111. Upon receipt of an instruction to change the first order, the changing unit 123 attaches the change information indicating the change from the first order to the changed second order, and stores the change information and the changed order into the order storage unit 111, for example. The changing unit 123 is an example of a storing unit.

The changing unit 123 receives an input to designate an order from a user, for example. Here, the designated order is equivalent to a pre-changed order. The changing unit 123 causes the output device 102 to display a change screen for changing the pre-changed order. The changing unit 123 receives an input of information for changing the pre-changed order from the user via the change screen. Here, the pre-changed order changed with the input information is equivalent to a changed order. The changing unit 123 attaches the order ID of the pre-changed order as a related order ID to the changed order. The changing unit 123 stores the changed order as a new record into the order storage unit 111. The changing unit 123 sets the inactive flag of the pre-changed order to “1”. The changing unit 123 updates the end date of the pre-changed order.

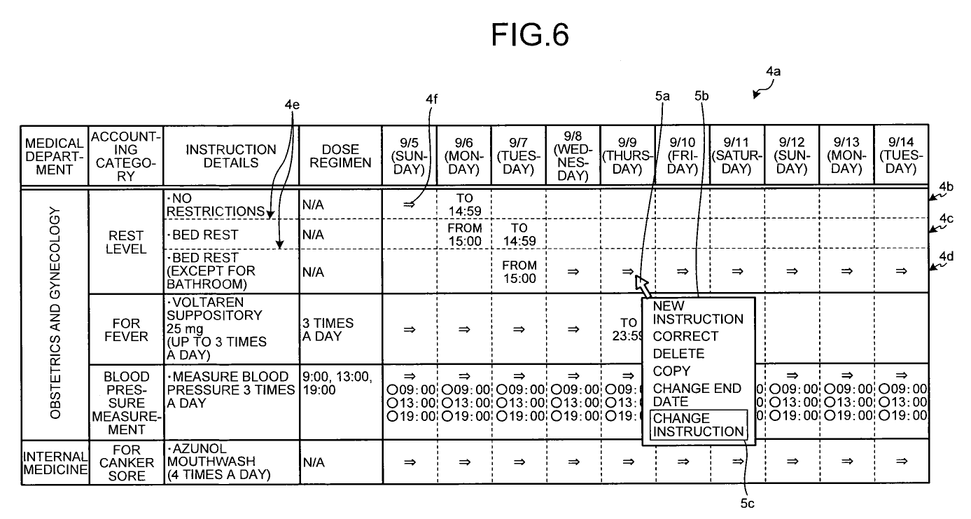

Referring now to FIGS. 6 through 9, operations of the changing unit 123 are described. FIGS. 6 through 9 are diagrams for explaining operations of the changing unit. FIG. 6 illustrates the same display screen 4a as FIG. 5. In FIG. 6, a mouse pointer 5a exists in the region of “2011/9/9” of the order 4d, and a menu screen 5b that appears when the mouse pointer 5a is right-clicked is displayed. Also, an instruction change button 5c for instructing to change an order exists on the menu screen 5b. Upon receipt of information indicating that the instruction change button 5c has been pressed, for example, the changing unit 123 senses that the order 4d has been selected as a pre-changed order by a user as illustrated in FIG. 6. The changing unit 123 obtains, from the order storage unit 111, the information about the order 4d selected by the user. The changing unit 123 causes the output device 102 to display a change screen for changing the order 4d.

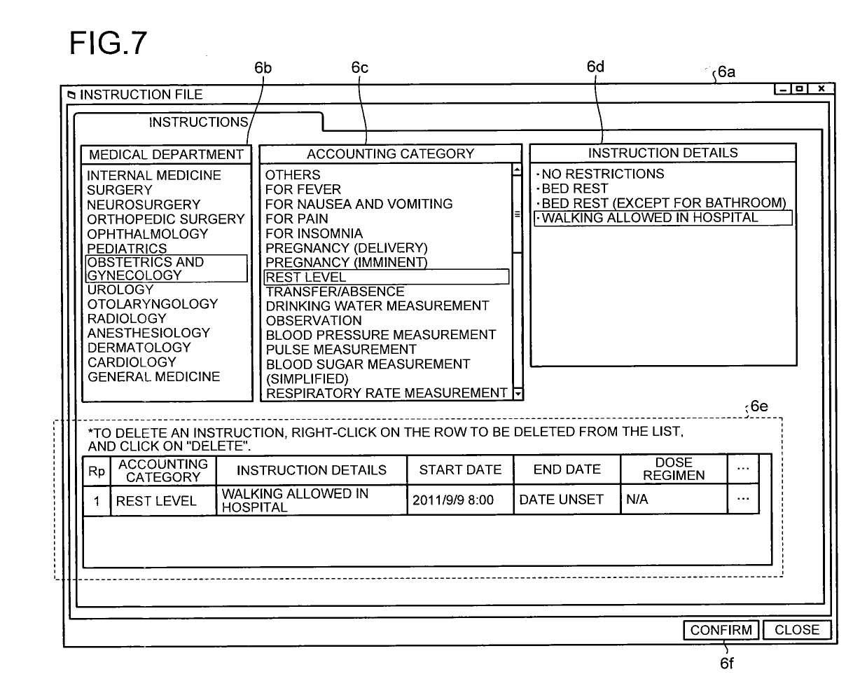

FIG. 7 illustrates a change screen 6a that is displayed for changing the order 4d, as an example. The change screen 6a includes a field 6b for selecting a medical department, a field 6c for selecting an accounting category, a field 6d for selecting instruction details, and a region 6e for inputting order information, for example. Based on the obtained information about the order 4d, the changing unit 123 selects “Obstetrics and Gynecology” in the field 6b and “Rest Level” in the field 6c in advance, for example. The changing unit 123 receives an input of an instruction from a user to select instruction details in the field 6d. In the region 6e, the changing unit 123 receives an input of information such as a start date, an end date, and a dose regimen from the user. Based on the details selected in the field 6c, the changing unit 123 has “Rest Level” displayed in the accounting category column in the region 6e. Based on the details selected in the field 6d, the changing unit 123 also has “Walking Allowed in Hospital” displayed in the instruction details column in the region 6e. The changing unit 123 also has the date “2011/9/9” displayed in the start date column, with the date being designated with the mouse pointer 5a on the display screen 4a of FIG. 6. Having sensed that a confirmation button 6f on the change screen 6a has been pressed, the changing unit 123 stores the received information as a changed order into the order storage unit 111.

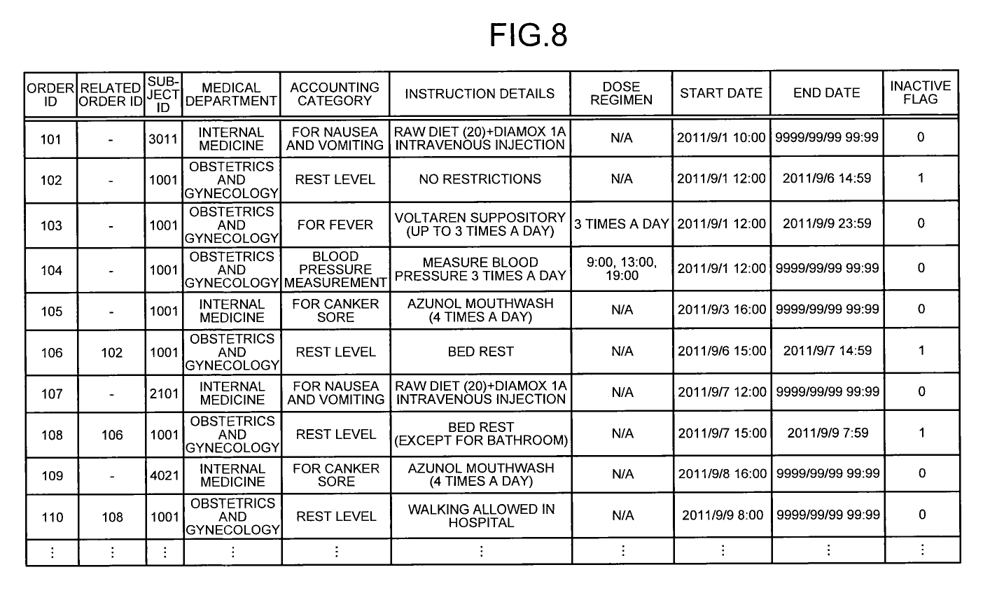

FIG. 8 illustrates a data structure in the order storage unit 111 in which the changed order is stored based on the change screen 6a of FIG. 7. The changed order stored based on the change screen 6a of FIG. 7 is equivalent to the order with an order ID “110” in FIG. 8. The pre-changed order designated with the mouse pointer 5a in FIG. 6 is equivalent to the order with the order ID “108” in FIG. 8. For example, the changing unit 123 attaches the order ID “108” of the pre-changed order as a related order ID to the order ID “110” of the changed order, and stores the changed order as a new record into the order storage unit 111. The changing unit 123 also sets the inactive flag of the order with the order ID “108” to “1”. The changing unit 123 also sets the end date of the order ID “108” to one minute before the start date of the changed order. Specifically, the changing unit 123 sets the time “2011/9/9 7:59”, which is one minute before the start date “2011/9/9 8:00” of the changed order, as the end date of the order ID “108”.

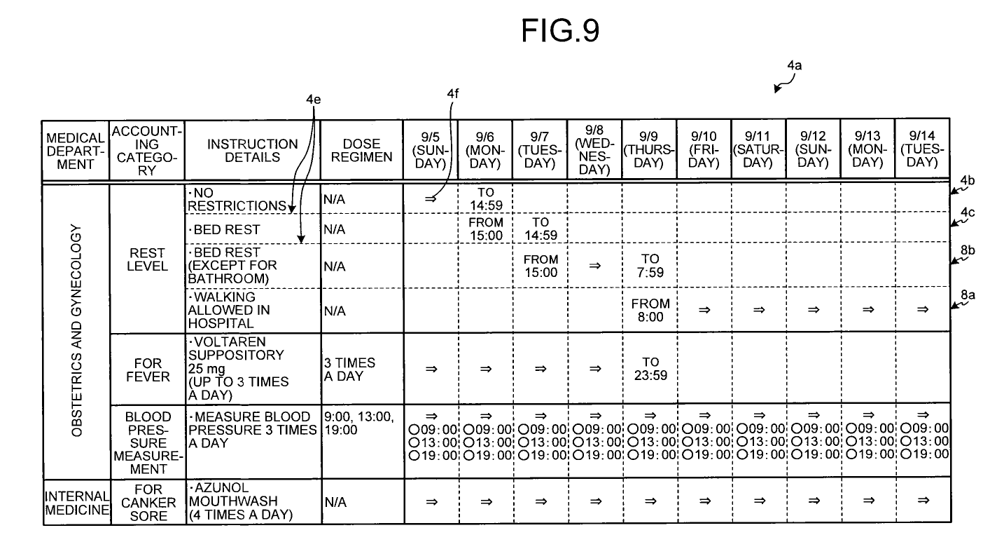

FIG. 9 illustrates a display screen 4a that is generated based on the order storage unit 111 illustrated in FIG. 8. As illustrated in FIG. 9, a changed order 8a is added to the display screen 4a. The order 4d that is changed in FIG. 6 is an order 8b in FIG. 9. From the display screen 4a illustrated in FIG. 9, the user can see that the order 8b has been changed to the order 8a at 8:00 on Sep. 9, 2011.

### Operations

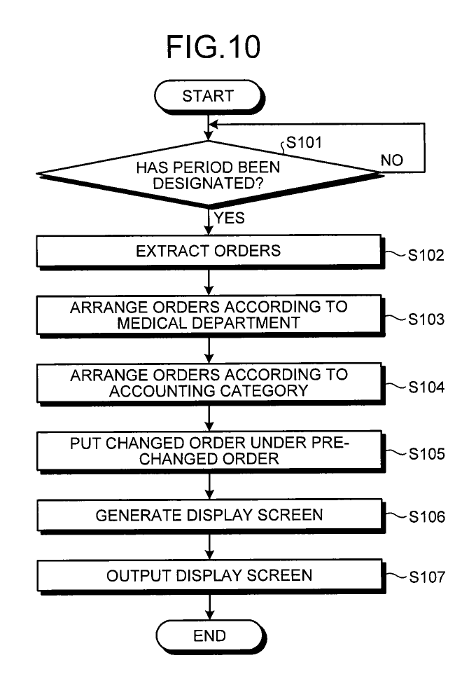

Next, the procedures in an operation of the order display apparatus 100 according to the first embodiment are described. FIG. 10 is a flowchart illustrating the procedures in an operation of the order display apparatus according to the first embodiment. The operation illustrated in FIG. 10 is performed at predetermined time intervals while power is supplied from a power source to the respective devices illustrated in the drawings, for example.

As illustrated in FIG. 10, upon receipt of an input to designate a period from a user (step S101: Yes), the extracting unit 121 extracts the orders that are valid during the designated period from the order storage unit 111 (step S102).

The generating unit 122 arranges the orders, which have been extracted by the extracting unit 121, according to medical department (step S103). The generating unit 122 further arranges the orders, which have been arranged according to medical department, according to accounting category (step S104). If there is a changed order among the orders arranged according to accounting category, the generating unit 122 puts the order under the corresponding pre-changed order (step S105). The generating unit 122 generates a display screen in the sequence of the arranged orders (step S106). The generating unit 122 causes the output device 102 to output the generated display screen (step S107).

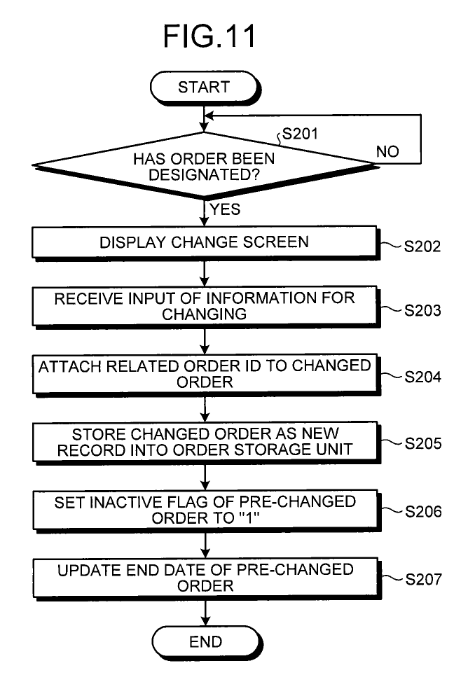

The procedures in an order changing operation to be performed to change an order in the order display apparatus 100 are now described. FIG. 11 is a flowchart illustrating the procedures in the order changing operation. The operation illustrated in FIG. 11 is performed at predetermined time intervals while power is supplied from a power source to the respective devices illustrated in the drawings, for example.

As illustrated in FIG. 11, upon receipt of an input to designate an order from a user (step S201: Yes), the changing unit 123 causes the output device 102 to display a change screen for changing a pre-changed order (step S202). Here, the designated order is equivalent to the pre-changed order.

The changing unit 123 receives an input of the information for changing the pre-changed order from the user via the change screen (step S203). Here, the pre-changed order changed with the input information is equivalent to a changed order.

The changing unit 123 attaches the order ID of the pre-changed order as a related order ID to the changed order (step S204). The changing unit 123 stores the changed order as a new record into the order storage unit 111 (step S205). The changing unit 123 sets the inactive flag of the pre-changed order to “1” (step S206). The changing unit 123 updates the end date of the pre-changed order (step S207).

### Advantages

Next, the advantages of the order display apparatus 100 according to the first embodiment are described. The order display apparatus 100 extracts orders having a designated period within the implementation periods thereof from a storage unit that stores change information indicating the relationships between one order among orders issued by doctors and the other orders, and the implementation period during which the one order is executed. In a case where the change information indicates that the extracted orders include a second order changed from a first order, the order display apparatus 100 performs the following operation. That is, the order display apparatus 100 have the first order and the second order displayed adjacent to each other on the display screen that displays at least some of the extracted orders in accordance with the passage of time during the designated period. Accordingly, the order display apparatus 100 can clearly display the process of the order change.

For example, if there is an order having a related order ID attached thereto, or a changed order, among the orders that are valid during a period designated by a user, the order display apparatus 100 puts the changed order under the order identified by the related order ID, or the pre-changed order. Accordingly, the order display apparatus 100 can clearly display the process of the order change, without another order being inserted and displayed between the pre-changed order and the changed order.

Also, the order display apparatus 100 generates the display screen that displays the time from the start time at which each order becomes valid until the end time at which the order becomes invalid. The time from the start time until the end time is displayed in a different format from the start time and the end time, for example. To display the period on the display screen on a daily basis, the order display apparatus 100 displays an arrow 4f for each of the days having orders that are valid all day, for example. Accordingly, the order display apparatus 100 can clearly display that each order that is valid on a day with an arrow 4f displayed thereon lasts at least from the previous day until the next day.

In a case where the period is displayed on the display screen on a daily basis, the order display apparatus 100 displays a time with “˜” on a day on which an order is valid from a predetermined time or is valid until a predetermined time, for example. If there is an order that is valid from 15:00, for example, the order display apparatus 100 displays “15:00˜” on the corresponding day. If there is an order that is valid until 14:00, the order display apparatus 100 displays “˜14:00” on the corresponding day. Accordingly, the order display apparatus 100 can display, in a plain manner, that an order that is valid on a day having “˜” displayed thereon lasts from the previous day until a predetermined time, or lasts from the predetermined time until the next day.

Also, the order display apparatus 100 generates a display screen that displays the line representing the boundary on which a first order and a second order are adjacent to each other, in a different format from the other lines among the lines indicating the boundaries on which orders are adjacent to each other on the display screen, for example. The order display apparatus 100 displays each line 4e with a dashed line indicating the boundary on which a pre-changed order and a changed order are adjacent to each other, for example. Accordingly, the order display apparatus 100 can display each line indicating the boundary on which a pre-changed order and a changed order are adjacent to each other, separately from the lines indicating the boundaries on which orders not involved in changes are adjacent to one another, and can clearly display the order change.

It should be noted that the structure of the order display apparatus 100 illustrated in FIG. 1 is a merely an example, and the order display apparatus 100 does not need to include all the processing units illustrated in FIG. 1. For example, the order display apparatus 100 may include only the extracting unit and the generating unit.

Specifically, the extracting unit extracts orders that are valid during a designated period, from the storage unit that stores orders issued by doctors. Based on the extracted orders, the generating unit generates a display screen that associates the passage of time during the period with the orders that are valid during the time and displays them. If there is a second order that is a changed order to which change information indicating a change from a first order is attached, the generating unit performs the following operation. That is, the generating unit generates a display screen on which the first order and the second order are displayed adjacent to each other. Accordingly, the order display apparatus 100 can clearly display the process of the order change.

### Second Embodiment

Although an embodiment of the present invention has been described so far, the present invention may be carried out in embodiments other than the above described embodiment. In the following, other embodiments are described.

### Data Center

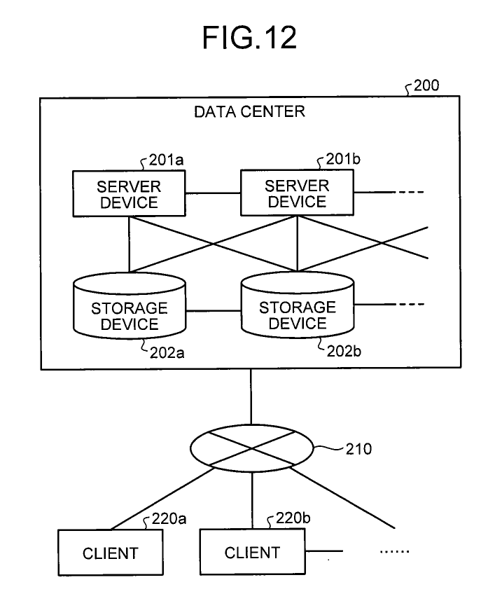

Although the order display apparatus 100 is installed at a medical institution in the first embodiment, the present invention is not limited to that. The order display apparatus 100 may be used in a data center that is connected to medical institutions. FIG. 12 is a diagram for explaining an example of the application to a data center. As illustrated in FIG. 12, a data center 200 is connected to clients 220a, 220b, . . . via a network 210, for example. The network 210 may be any wired or wireless communication network, such as the Internet or a WAN (Wide Area Network). The clients 220a, 220b, . . . are distributed and installed at medical institutions. The data center 200 also includes server devices 201a, 201b, . . . and storage devices 202a, 202b, . . . . Where there is no need to distinguish the clients 220a, 220b, . . . from one another, the clients 220a, 220b, . . . are collectively referred to as clients 220. Also, where there is no need to distinguish the server devices 201a, 201b, . . . from one another, the server devices 201a, 201b, . . . are collectively referred to as server devices 201. Also, where there is no need to distinguish the storage devices 202a, 202b, . . . from one another, the storage devices 202a, 202b, . . . are collectively referred to as storage devices 202.

The data center 200 uses the server devices 201, to realize the functions of the order display apparatus 100 illustrated in FIG. 1 as a virtual machine, for example. The data center 200 also uses the storage devices 202, to store the order storage unit 111 illustrated in FIG. 1 for each hospital, for example.

In the data center 200, an order display VM (Virtual Machine) that serves as the virtual machine executing the functions of the order display apparatus 100 performs operations in the following manner, for example. That is, the order display VM extracts orders having a designated period within the implementation periods thereof, from a storage unit that stores change information indicating the relationships between one order among orders issued by doctors and the other orders, and the implementation period during which the one order is executed. If the extracted orders include a second order indicating a change from a first order, the order display VM performs the following operation. That is, the order display VM has the first order and the second order displayed adjacent to each other on a display screen that displays at least some of the extracted orders in accordance with the passage of time during the designated period. Accordingly, the order display VM can clearly display the process of the order change.

### Others

Although an order is changed within the same medical department and the same accounting category in the first embodiment, the present invention is not limited to that. In a case where an order is changed regardless of medical department and accounting category, for example, the present invention can also be applied. For example, even in a case where the accounting category differs between a pre-changed order and a changed order, the order display apparatus 100 may attach the order ID of the pre-changed order as a related order ID to the changed order, and store the changed order into the order storage unit 111. Where an order is changed regardless of medical department and accounting category as above, the treatment course of the subject might be changed from a medication treatment to an exercise therapy, for example.

Also, among the operations described in the first embodiment, all of or part of the operations that are automatically performed in the above described embodiment can be manually performed, or all of or part of the operations that are manually performed in the above described embodiment can be automatically performed by a known technique, for example. In the first embodiment, the order ID of a pre-changed order is automatically attached as a related order ID to a changed order. However, a user may directly access the order storage unit 111, and input a related order ID, for example. Also, in the first embodiment, a designated date that defines the period of display on a display screen is received as a manual input from a user. However, the current date may be automatically input as a designated date, for example. Other than the above, the procedures in operations, the procedures in control operations, the specific names, and the information containing the various kinds of data and parameters, which have been described and illustrated in the above specification and drawings, can be arbitrarily modified, unless otherwise stated. For example, the medical departments and the accounting categories are not necessarily displayed on the display screen 4a.

The respective components of the order display apparatus 100 illustrated in FIG. 1 are merely conceptual functions, and do not need to have physical structures as in the drawing. That is, specific embodiments of division and combination of the order display apparatus 100 are not limited to that in the drawing, and part of or all of the order display apparatus 100 can be functionally or physically divided or combined on an arbitrary basis, depending on various loads and the status of use. For example, an external storage device may be connected to the order display apparatus 100 via a network so that the external storage device can store the information stored in the storage unit 110.

Also, the order display apparatus 100 can be realized by installing the respective functions of the order display apparatus 100 in a known information processing apparatus. The known information processing apparatus is equivalent to an apparatus such as a personal computer, a workstation, a portable telephone, a PHS (Personal Handy-phone System) terminal, a mobile communication terminal, or a PDA (Personal Digital Assistant).

### Program

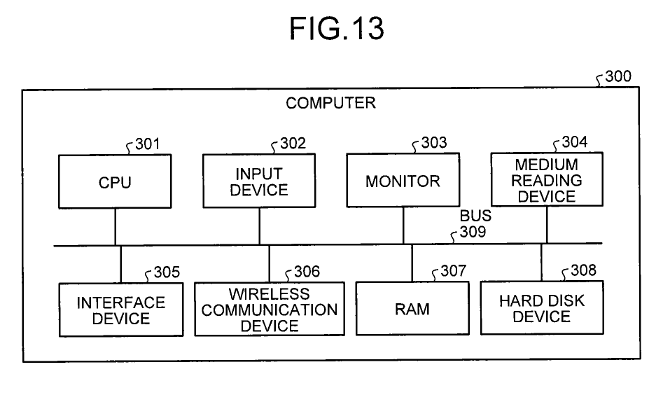

FIG. 13 is a diagram illustrating an example of a computer that executes an order display program. As illustrated in FIG. 13, a computer 300 includes a CPU 301 that performs various kinds of arithmetic operations, an input device 302 that receives a data input from a user, and a monitor 303. The computer 300 also includes a medium reading device 304 that reads a program and the like from a storage medium, an interface device 305 for connecting to another apparatus, and a wireless communication device 306 for wirelessly connecting to another apparatus. The computer 300 also includes a RAM (Random Access Memory) 307 that temporarily stores various kinds of information, and a hard disk device 308. The respective devices 301 through 308 are connected to a bus 309.

An order display program having the same functions as the respective processing units of the extracting unit 121 and the generating unit 122 illustrated in FIG. 1 is stored in the hard disk device 308. Various kinds of data for realizing the order display program are also stored in the hard disk device 308.

The CPU 301 reads respective programs stored in the hard disk device 308, and loads the programs into the RAM 307, to perform various kinds of operations. Those programs can cause the computer to function as the extracting unit 121 and the generating unit 122 illustrated in FIG. 1.

The above described order display program is not necessarily stored in the hard disk device 308. For example, a program stored in a computer-readable recording medium may be read and executed by the computer 300. The computer-readable recording medium is equivalent to a portable recording medium such as a CD-ROM, a DVD disk, or a USB memory, a semiconductor memory such as a flash memory, a hard disk drive, or the like. This program may be stored in a device connected to a public line, the Internet, a LAN (Local Area Network), a WAN (Wide Area Network), or the like, and the computer 300 may read the program from the device, and then execute the program.

According to an aspect of a technique disclosed in this application, the process of each order change can be clearly displayed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An order display apparatus comprising:
a processor; and
a memory that stores change information indicating the relationships between one order among orders issued by doctors and another order among the issued orders, and an implementation period during which the one order is executed, wherein the processor executes:
extracting orders having a designated period within the implementation periods thereof, from the memory; and
displaying a first order and a second order adjacent to each other on a display screen that displays at least some of the extracted orders in accordance with the passage of time during the designated period, when the orders extracted at the extracting include the second order having the change information that indicates that the second order has been changed from the first order.

2. The order display apparatus according to claim 1, wherein the processor further executes storing the second order and the change information indicating the change from the first order to the second order into the memory, upon receipt of an instruction to change the first order stored in the storage unit to the second order.

3. The order display apparatus according to claim 1, wherein
the displaying includes generating the display screen that displays the time from a start time at which each order becomes valid until an end time at which the order becomes invalid, the time from the start time until the end time being displayed in a different format from the start time and the end time.

4. The order display apparatus according to claim 1, wherein
the displaying includes displaying the first order and the second order adjacent to each other includes having a first implementation period and a second implementation period displayed on the display screen in such a manner that the connection between the end date of the first implementation period of the first order and the start date of the second implementation period of the second order is recognized.

5. The order display apparatus according to claim 1, wherein
the displaying includes generating the display screen that displays a line indicating a boundary on which the first order and the second order are adjacent to each other in a different format from another line indicating another boundary on which orders are adjacent to one another on the display screen.

6. A computer-readable storage medium storing therein an order display program causing a computer to perform:
extracting orders having a designated period within the implementation periods thereof, from a storage unit that stores change information indicating the relationships between one order among orders issued by doctors and the other orders among the issued orders, and the implementation period during which the one order is executed; and
displaying a first order and a second order adjacent to each other on a display screen that displays at least some of the extracted orders in accordance with the passage of time during the designated period, when the orders extracted through the order extracting operation include the second order having the change information that indicates that the second order has been changed from the first order.

7. A computer-readable storage medium according to claim 6, further causing the computer to perform storing the second order and the change information into the storage unit, upon receipt of an instruction to change the first order stored in the storage unit to the second order in a case of attaching the change information indicating the change from the first order to the second order.

8. A computer-readable storage medium according to claim 6, wherein
the displaying includes generating the display screen that displays the time from a start time at which each order becomes valid until an end time at which the order becomes invalid, the time from the start time until the end time being displayed in a different format from the start time and the end time.

9. A computer-readable storage medium according to claim 6, wherein
the displaying includes having a first implementation period and a second implementation period displayed on the display screen in such a manner that the connection between the end date of the first implementation period of the first order and the start date of the second implementation period of the second order can be recognized.

10. A computer-readable storage medium according to claim 6, wherein
the displaying includes generating the display screen that displays the line indicating the boundary on which the first order and the second order are adjacent to each other in a different format from the other lines among the lines indicating the boundaries on which orders are adjacent to one another on the display screen.

11. An order display method implemented by a server device, the order display method including:
extracting, using a processor, orders having a designated period within the implementation periods thereof, from a storage unit that stores change information indicating the relationships between one order among orders issued by doctors and the other orders among the issued orders, and the implementation period during which the one order is executed; and
displaying a first order and a second order adjacent to each other on a display screen that displays at least some of the extracted orders in accordance with the passage of time during the designated period, when the orders extracted through the order extracting operation include the second order having the change information that indicates that the second order has been changed from the first order.

12. The order display method of claim 11, further including storing the second order and the change information into the storage unit, upon receipt of an instruction to change the first order stored in the storage unit to the second order in a case of attaching the change information indicating the change from the first order to the second order.

13. The order display method of claim 11, wherein
the displaying includes generating the display screen that displays the time from a start time at which each order becomes valid until an end time at which the order becomes invalid, the time from the start time until the end time being displayed in a different format from the start time and the end time.

14. The order display method of claims 11, wherein
the displaying includes having a first implementation period and a second implementation period displayed on the display screen in such a manner that the connection between the end date of the first implementation period of the first order and the start date of the second implementation period of the second order can be recognized.

15. The order display method of claim 11, wherein
the displaying includes generating the display screen that displays the line indicating the boundary on which the first order and the second order are adjacent to each other in a different format from the other lines among the lines indicating the boundaries on which orders are adjacent to one another on the display screen.
